(19) United States
(12) Patent Application Publication
(10) Pub. No.: US 2026/0195428 A1
(43) Pub. Date: Jul. 9, 2026

(54) AUTHENTICATING A USER FOR AN APPLICATION USING PASSWORDLESS IDENTIFYING INFORMATION

(71) Applicant: Palo Alto Networks, Inc., Santa Clara, CA (US)

(72) Inventors: Brian David Levin, San Francisco, CA (US); Imran Muhammad Bashir, San Jose, CA (US); Jianguo Hu, Santa Clara, CA (US); Jyhchia Josephine Yu, Fremont, CA (US)

(21) Appl. No.: 19/013,999

(22) Filed: Jan. 8, 2025

(51) Int. Cl. G06F 21/31

(52) U.S. Cl. CPC G06F 21/31

(57) ABSTRACT

Access to an application is requested. A user associated with the request is authenticated using passwordless authentication information via a cloud authentication service. A credential associated with the application to access the application is received from the cloud authentication service. Access to the application is obtained in response to providing the credential to the application

### BACKGROUND OF THE INVENTION

Passwordless authentication is a method of verifying a user's identity without requiring them to enter a traditional password to access an application. Instead, the user may provide biometric information, a one-time password, a key outputted by a physical device, the user may approve a login attempt sent via a push notification, scan a barcode, or perform any other FIDO2 compliant authentication. Passwordless authentication aims to reduce security risks associated with password management, such as weak or reused passwords. Some legacy applications are not designed for passwordless authentication and require users to rely on traditional passwords. As a result, these applications may be subject to security breaches due to credential theft. These legacy applications must be decommissioned and then replaced, which requires capital expenditure investments.

### BRIEF DESCRIPTION OF THE DRAWINGS

Various embodiments of the invention are disclosed in the following detailed description and the accompanying drawings.

FIG. 1 is a block diagram illustrating a system to perform passwordless authentication in accordance with some embodiments.

FIG. 2 is a block diagram illustrating a process to perform passwordless authentication in accordance with some embodiments.

FIG. 3 is a block diagram illustrating a system to perform passwordless authentication in accordance with some embodiments.

FIG. 4 is a block diagram illustrating a process to perform passwordless authentication in accordance with some embodiments.

FIG. 5 is a block diagram illustrating a system to perform passwordless authentication in accordance with some embodiments.

FIG. 6 is a block diagram illustrating a process to perform passwordless authentication in accordance with some embodiments.

FIG. 7 is a block diagram illustrating a system to perform passwordless authentication in accordance with some embodiments.

FIG. 8 is a block diagram illustrating a process to perform passwordless authentication in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Systems and methods to implement passwordless authentication are disclosed herein. The systems and methods disclosed herein improve the security posture associated with applications, preventing against commonly exploited identity-based attacks, such as credential comprise, multi-factor authentication bypass, multi-factor authentical fatigue, SIM, swapping, etc. The systems and methods disclosed herein simplify an end-user's authentication experience, providing secure access with a single biometric scan (fingerprint, face, etc.) without the need for multiple authentication factors. The systems and methods disclosed herein reduce password management burden, removing the need for constant password resets and refreshes. The systems and methods disclosed herein enable a legacy application to become a single sign on (SSO)-enabled application.

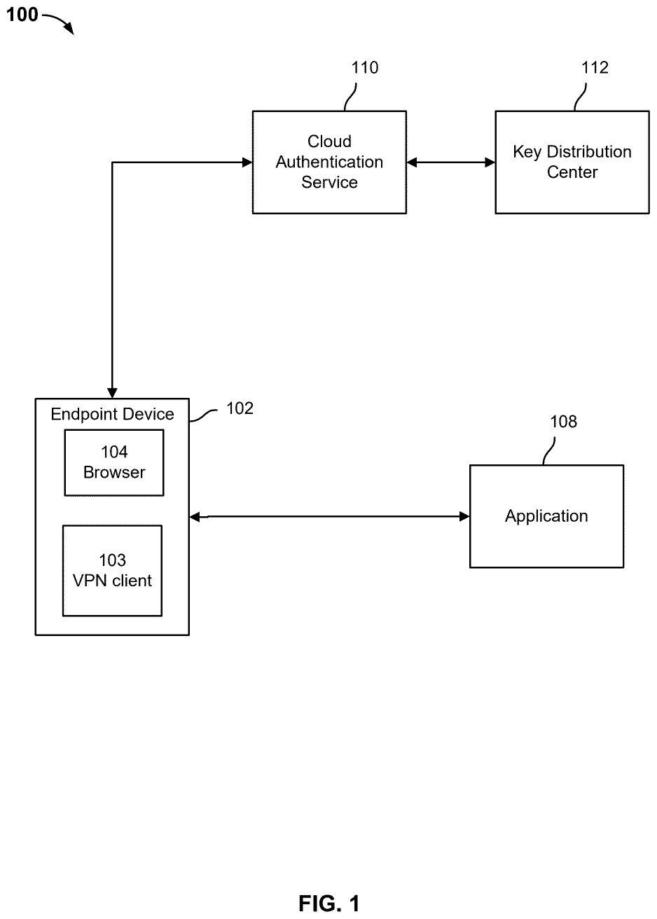

FIG. 1 is a block diagram illustrating a system to perform passwordless authentication in accordance with some embodiments. In the example shown, system 100 includes an endpoint device 102 associated with a user. Endpoint device 102 may be a computer, a tablet, a smartphone, a personal digital assistant, or any other computing device. Endpoint device 102 is a device trying to remotely access application 108. The user logs into endpoint device 102 using passwordless identifying information. The passwordless identifying information may include biometric information, a personal identification number (PIN), a one-time password, a key outputted by a physical device, the user may approve a login attempt sent via a push notification, a barcode scan, any other FIDO2 compliant authentication, or other identifying information. The PIN may be a numerical PIN or an alphanumeric PIN. The user opens browser 104 to access application 108 via a virtual private network (VPN) generated by VPN client 103. Browser 104 sends an access request to application 108. In response to the access request, application 108 provides an authentication challenge. For example, application may provide a 401 challenge that prompts browser 104 to authenticate itself before access to application 108 is granted. The 401 challenge may indicate that browser 104 needs to provide a credential, such as a ticket or a token.

VPN client 103 is configured to intercept the authentication challenge and authenticate the passwordless identifying information with cloud authentication service 110. Cloud authentication service 110 provides user identification and user authentication for a centralized cloud-based solution in on-premise, cloud-based, or hybrid network environments. Cloud authentication service 110 enables administrators to write a security policy based on users and groups, not IP addresses, and helps secure assets by enforcing behavior-based security actions.

Cloud authentication service 110 is registered with key distribution center 112 (e.g., Kerberos key distribution center, Lightweight Director Access Protocol (LDAP), Radius, etc.). The registration indicates the one or more applications to which one or more users may access. Constrained delegation is provided to cloud authentication service 110, which allows cloud authentication service 110 to impersonate a user and access resources on behalf of the user, but only for the one or more applications to which the user has access. Key distribution center 112 includes an authentication server and a credential granting server. The authentication server is configured to verify a user's passwordless identifying information during an initial login. If the user's passwordless identifying information is valid, it issues a ticket granting ticket, which is encrypted and used for further authentication requests without repeatedly asking for a password. After obtaining a ticket granting ticket, a user can request access to specific services or applications. The ticket granting server is configured to issue credentials (e.g., service tickets, service tokens) to access those services securely.

In response to authenticating the user's passwordless identifying information, cloud authentication service 110 is configured to send a request for a credential to key distribution center 112. In some embodiments, the credential is a ticket. In some embodiments, the credential is a token. In response to the request, key distribution center 112 is configured to provide a credential associated with application 108 to cloud authentication service 110. Cloud authentication service 110 provides the credential to endpoint device 102. Browser 104 provides the credential to application 108. In response to receiving the credential, application 108 is configured to provide access to browser 104.

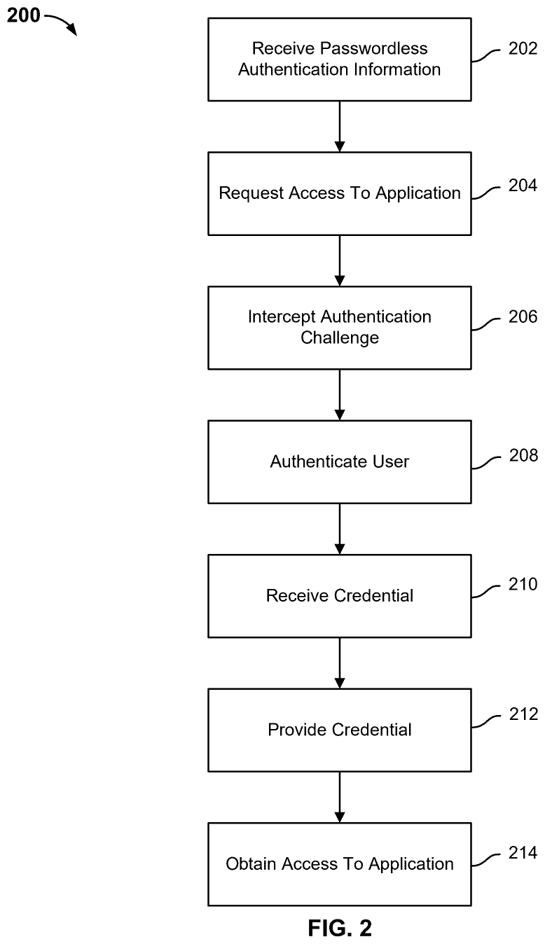

FIG. 2 is a block diagram illustrating a process to perform passwordless authentication in accordance with some embodiments. Process 200 may be implemented by a VPN client, such as VPN client 103.

At 202, passwordless authentication information is received via an endpoint device. The passwordless authentication information may include biometric information, a personal identification number (PIN), a one-time password, a key outputted by a physical device, the user may approve a login attempt sent via a push notification, a barcode scan, any other FIDO2 compliant authentication, or other identifying information.

At 204, access to an application is requested. The VPN client generates a VPN between a browser and the application. The browser sends a request for access to the application via the VPN. The endpoint device is a device trying to remotely access the application.

At 206, an authentication challenge is intercepted. In response to receiving the request, the application sends the authentication challenge to the browser. The authentication challenge may be a 401 challenge or other authentication challenge. The VPN client intercepts the authentication challenge.

At 208, the user is authenticated. The VPN client provides the passwordless authentication information to a cloud authentication service. The cloud authentication service is registered with a key distribution center and provided constrained delegation. Constrained delegation allows the cloud authentication service to impersonate a user and access resources on behalf of the user, but only for the one or more applications to which the user has access.

Upon authenticating the user, the cloud authentication service sends to the key distribution center a request for a credential associated with the application. In response, the key distribution center is configured to provide the credential associated with the application to the cloud authentication service. In some embodiments, the credential associated with the application is a ticket. In some embodiments, the credential associated with the application is a token.

At 210, a credential is received. The cloud authentication service provides the credential associated with the application to the VPN client.

At 212, the credential is provided. The VPN client provides the credential associated with the application to the application.

At 214, access to the application is obtained. In response to receiving the credential, the application grants the browser with access to the application.

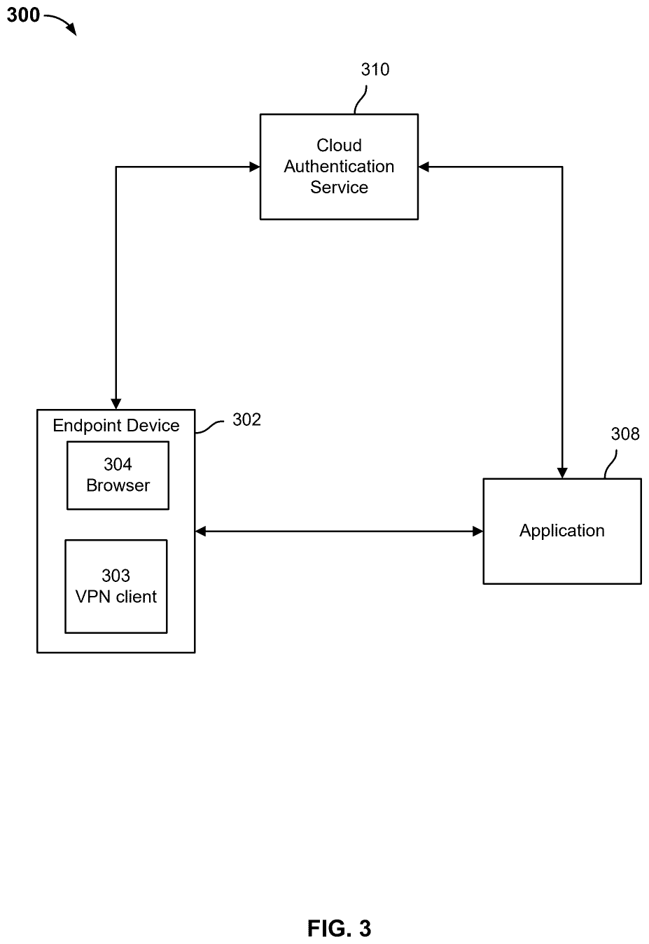

FIG. 3 is a block diagram illustrating a system to perform passwordless authentication in accordance with some embodiments. In the example shown, system 300 includes an endpoint device 302 associated with a user. Endpoint device 302 may be a computer, a tablet, a smartphone, a personal digital assistant, or any other computing device. The user logs into endpoint device 302 using passwordless identifying information. Endpoint device 302 is a device trying to remotely access application 308. The passwordless identifying information may include biometric information, a PIN, a one-time password, a key outputted by a physical device, the user may approve a login attempt sent via a push notification, a barcode scan, any other FIDO2 compliant authentication, or other identifying information. The PIN may be a numerical PIN or an alphanumeric PIN. The user opens browser 304 to access application 308 via a VPN generated by VPN client 303. Browser 304 sends an access request to application 308 via the VPN. In response to the access request, application 308 redirects the request to cloud authentication service 310. Application 308 is a software or service that supports authentication using the security assertion markup language (SAML) protocol.

VPN client 103 is configured to provide the passwordless identifying information to cloud authentication service 110. In response to authenticating the passwordless identifying information, cloud authentication service is configured to send a credential for application 308 to VPN client 303. VPN client 303 provides the credential to application 308. In response to receiving the credential, application 308 is configured to provide access to browser 304.

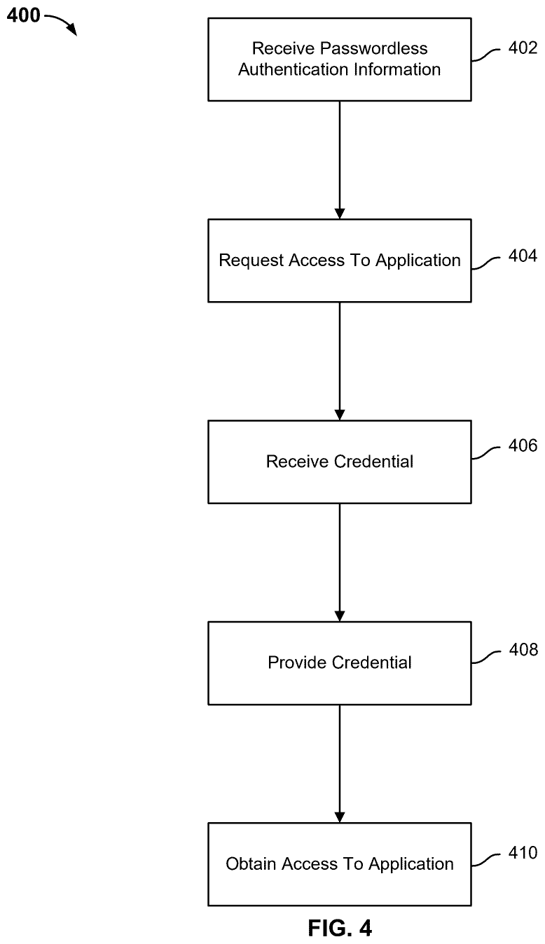

FIG. 4 is a block diagram illustrating a process to perform passwordless authentication in accordance with some embodiments. Process 400 may be implemented by a VPN client, such as VPN client 303.

At 402, passwordless authentication information is received via an endpoint device. The passwordless authentication information may include biometric information, a PIN, a one-time password, a key outputted by a physical device, the user may approve a login attempt sent via a push notification, a barcode scan, any other FIDO2 compliant authentication, or other identifying information.

At 404, access to an application is requested. An access request is provided from a browser to the application via a VPN generated by the VPN client. The endpoint device is a device trying to remotely access an application.

At 406, a credential is received. In response to the access request, the application redirects the request to a cloud authentication service. The application is a software or service that supports authentication using the SAML protocol. The VPN client provides the passwordless identifying information to the cloud authentication service. In response to authenticating the passwordless identifying information, the cloud authentication service sends a credential for the application to the VPN client.

At 408, the credential is provided. The VPN client provides the credential to the application.

At 410, access to the application is obtained. In response to receiving the credential, the application provides access to the browser.

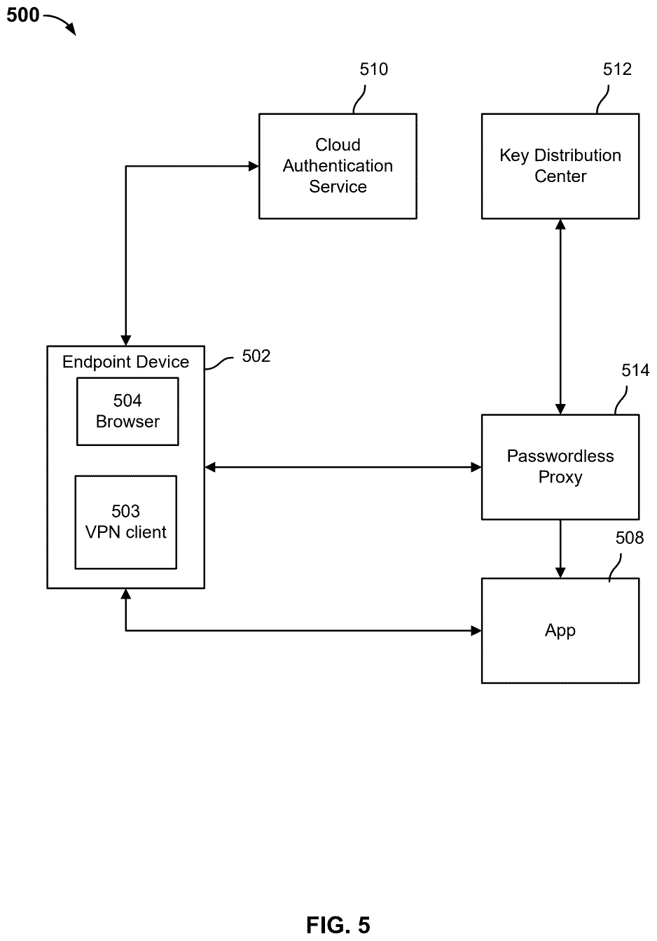

FIG. 5 is a block diagram illustrating a system to perform passwordless authentication in accordance with some embodiments. In the example shown, system 500 includes an endpoint device 502 associated with a user. Endpoint device 502 is an on-premises device trying to access application 508. Endpoint device 502 is located on-premises. Endpoint device 102 may be a computer, a tablet, a smartphone, a personal digital assistant, or any other computing device. The user logs into endpoint device 502 using passwordless identifying information. The passwordless identifying information may include biometric information, a PIN, a one-time password, a key outputted by a physical device, the user may approve a login attempt sent via a push notification, a barcode scan, any other FIDO2 compliant authentication, or other identifying information. The PIN may be a numerical PIN or an alphanumeric PIN. The user opens browser 504 to access application 508 via a VPN generated by VPN client 503. Browser 504 sends an access request to application 508 via Passwordless Proxy 514. A passwordless proxy is a security mechanism that facilitates authentication and access control without requiring users to enter passwords. Instead, it relies on other authentication methods, such as biometric data, hardware tokens, or cryptographic keys.

Passwordless Proxy 514 redirects the request to cloud authentication service 510 via VPN client 503. VPN client 503 is configured to provide the passwordless identifying information to cloud authentication service 510. In response to cloud authentication service 510 authenticating the passwordless identifying information, VPN client 103 provides an authorization request to application 508 via passwordless proxy 514. In response to receiving the authorization request, passwordless proxy 514 requests a credential from key distribution center 512. In some embodiments, the credential is a ticket. In some embodiments, the credential is a token.

In response to the request, key distribution center 512 is configured to provide the credential associated with application 508 to passwordless proxy 514. Passwordless proxy 514 is configured to provide the access request and the credential associated with the application to application 508. In response to receiving the access request and the credential, application 508 is configured to provide access to browser 504.

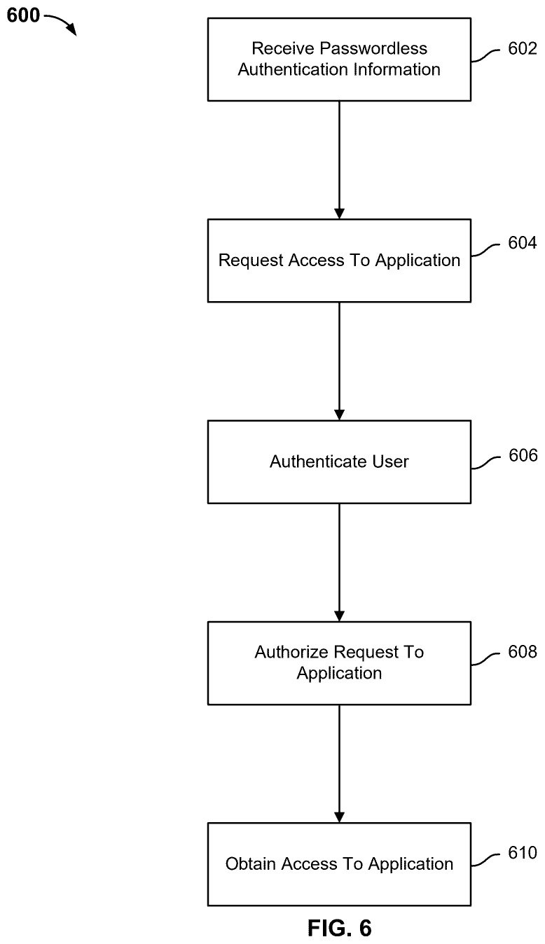

FIG. 6 is a block diagram illustrating a process to perform passwordless authentication in accordance with some embodiments. Process 600 may be implemented by a VPN client, such as VPN client 103.

At 602, passwordless authentication information is received. The passwordless identifying information may include biometric information, a PIN, a one-time password, a key outputted by a physical device, the user may approve a login attempt sent via a push notification, a barcode scan, any other FIDO2 compliant authentication, or other identifying information. The PIN may be a numerical PIN or an alphanumeric PIN.

At 604, access to an application is requested. The VPN client generates a VPN between a browser and the application. The browser sends a request for access to the application via the VPN. A passwordless proxy is located between the browser and the application. The passwordless proxy redirects the request to a cloud authentication service to authenticate a user associated with the passwordless authentication information.

At 606, a user is authenticated. The VPN client provides the passwordless identifying information to the cloud authentication service.

At 608, an authorization request is provided to the application. In response to the cloud authentication service authenticating the passwordless identifying information, the VPN client provides an authorization request to the application via the passwordless proxy.

At 610, access to the application is obtained. In response to receiving the authorization request, the passwordless proxy requests a credential from a key distribution center. In some embodiments, the credential is a ticket. In some embodiments, the credential is a token.

In response to the request, the key distribution center provides the credential associated with the application to the passwordless proxy. The passwordless proxy provides the access request and the credential associated with the application to the application. In response to receiving the access request and the credential, the application provide access to the browser.

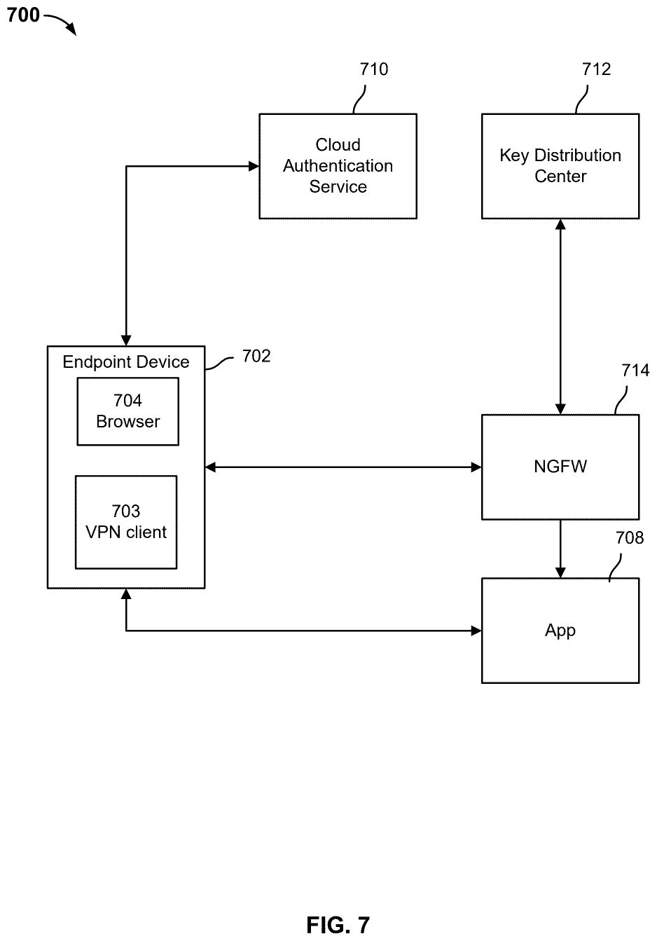

FIG. 7 is a block diagram illustrating a system to perform passwordless authentication in accordance with some embodiments. In the example shown, system 700 includes an endpoint device 702 associated with a user. Endpoint device 702 is an on-premises device trying to access application 708. Endpoint device 702 may be a computer, a tablet, a smartphone, a personal digital assistant, or any other computing device. The user logs into endpoint device 702 using passwordless identifying information. The passwordless identifying information may include biometric information, a PIN, a one-time password, a key outputted by a physical device, the user may approve a login attempt sent via a push notification, a barcode scan, any other FIDO2 compliant authentication, or other identifying information. The PIN may be a numerical PIN or an alphanumeric PIN. The user opens browser 704 to access application 708 via a VPN generated by VPN client 703. Browser 704 sends an access request to application 708 via next generation firewall (NGFW) 714. A NGFW is an advanced type of firewall that provides comprehensive network security by integrating traditional firewall capabilities with additional features, such as application awareness, intrusion prevention, and advanced threat detection.

NGFW 714 redirects the request to cloud authentication service 710 via VPN client 703. VPN client 703 is configured to provide the passwordless identifying information to cloud authentication service 710. In response to cloud authentication service 710 authenticating the passwordless identifying information, VPN client 703 is configured to provide an authorization request to application 708 via NGFW 714. In response to receiving the authorization request, NGFW 714 requests a credential from key distribution center 712. In some embodiments, the credential is a ticket. In some embodiments, the credential is a token.

In response to the request, key distribution center 712 is configured to provide the credential associated with application 708 to NGFW 714. NGFW 714 provides the access request and the credential associated with the application to application 708. In response to receiving the access request and the credential, application 708 is configured to provide access to browser 704.

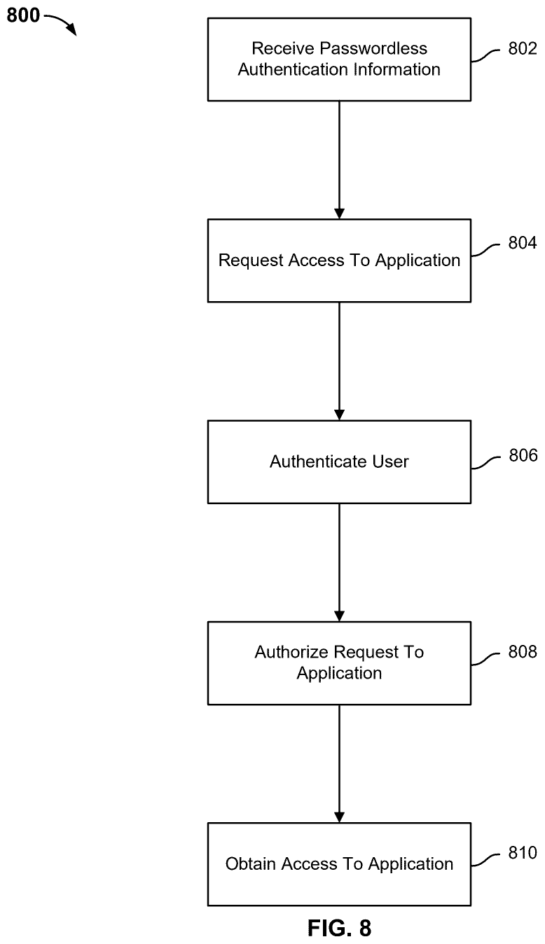

FIG. 8 is a block diagram illustrating a process to perform passwordless authentication in accordance with some embodiments.

At 802, passwordless authentication information is received. The passwordless identifying information may include biometric information, a PIN, a one-time password, a key outputted by a physical device, the user may approve a login attempt sent via a push notification, a barcode scan, any other FIDO2 compliant authentication, or other identifying information. The PIN may be a numerical PIN or an alphanumeric PIN.

At 804, access to an application is requested. The VPN client generates a VPN between a browser and the application. The browser sends a request for access to the application via the VPN. An NGFW is located between the browser and the application. The NGFW redirects the request to a cloud authentication service to authenticate a user associated with the passwordless authentication information.

At 806, a user is authenticated. The VPN client provides the passwordless identifying information to the cloud authentication service.

At 808, the authorization request is provided to the application. In response to the cloud authentication service authenticating the passwordless identifying information, the VPN client provides an authorization request to the application via the NGFW.

At 810, access to the application is obtained. In response to receiving the authorization request, the NGFW requests a credential from a key distribution center. In some embodiments, the credential is a ticket. In some embodiments, the credential is a token.

In response to the request, the key distribution center provides the credential associated with the application to the NGFW. The NGFW provides the access request and the credential associated with the application to the application. In response to receiving the access request and the credential, the application provide access to the browser.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
requesting access to an application;
authenticating a user associated with the request using passwordless authentication information via a cloud authentication service;
receiving a credential associated with the application to access the application from the cloud authentication service; and
obtaining access to the application in response to providing the credential to the application.

2. The method of claim 1, wherein the passwordless authentication information includes biometric data or a personal identification number.

3. The method of claim 1, further comprising receiving the passwordless authentication information.

4. The method of claim 1, wherein a browser associated with an endpoint device requests the access to the application.

5. The method of claim further comprising intercepting an authentication challenge from the application.

6. The method of claim 5, wherein the authentication challenge is a request for a credential associated with the application.

7. The method of claim 5, wherein the authentication challenge is HTTP 401 challenge.

8. The method of claim 5, wherein a virtual private network client intercepts the authentication challenge from the application.

9. The method of claim 1, wherein the cloud authentication service authenticates the user associated with the request using the passwordless authentication information and requests for a credential associated with the application from a key distribution center.

10. The method of claim 9, wherein the cloud authentication service is given constrained delegation rights for the user.

11. The method of claim 9, wherein the key distribution center provides the credential associated with the application to the cloud authentication service.

12. The method of claim 1, wherein the credential associated with the application is a token.

13. The method of claim 1, wherein the credential associated with the application is a ticket.

14. The method of claim 1, further comprising providing the credential associated with the application to the application.

15. A system, comprising:
a processor configured to:
request access to an application;
authenticate a user associated with the request using passwordless authentication information via a cloud authentication service;
receive a credential associated with the application to access the application from the cloud authentication service; and
obtain access to the application in response to providing the credential to the application; and
a memory coupled to the processor and configured to provide the processor with instructions.

16. The system of claim 15, wherein the passwordless authentication information includes biometric data or a personal identification number.

17. The system of claim 17, wherein a browser associated with an endpoint device requests the access to the application.

18. The system of claim 17, wherein a virtual private network client is configured to intercept an authentication challenge from the application.

19. The system of claim 15, wherein the credential associated with the application is a token or a ticket.

20. A computer program product embodied in a non-transitory computer readable medium and comprising computer instructions for:
requesting access to an application;
authenticating a user associated with the request using passwordless authentication information via a cloud authentication service;
receiving a credential associated with the application to access the application from the cloud authentication service; and
obtaining access to the application in response to providing the credential to the application.
